(19) United States
(12) Patent Application Publication
(10) Pub. No.: US 2025/0384183 A1
(43) Pub. Date: Dec. 18, 2025

(54) COMPUTING SYSTEM FOR DESIGN OF IMAGE SENSOR

(71) Applicant: SAMSUNG ELECTRONICS CO., LTD., SUWON-SI (KR)

(72) Inventors: DAE-JUNG KIM, Suwon-si (KR); HYUNSOO JUNG, Suwon-si (KR)

(21) Appl. No.: 19/175,239

(22) Filed: Apr. 10, 2025

(30) Foreign Application Priority Data
Jun. 14, 2024 (KR) 10-2024-0077460

(51) Int. Cl. G06F 30/20

(52) U.S. Cl. CPC G06F 30/20

(57) ABSTRACT

A computing system including at least one processor, and a non-transitory computer-readable storage medium electrically connected to the at least one processor and storing a command executed by the at least one processor, where when the command is executed through the at least one processor, the command causes the at least one processor to: obtain a target product specification information describing a target image sensor, generate a design element based on the target product specification information, and generate, using a model generation module, a design model of the target image sensor based on the target product specification information and the design element, wherein the design model includes at least one of a layout model, a circuit model, a test model, or a process model of the target image sensor.

### CROSS-REFERENCE TO RELATED APPLICATION

This U.S. non-provisional patent application claims priority under 35 U.S.C. § 119 to Korean Patent Application No. 10-2024-0077460 filed on Jun. 14, 2024 in the Korean Intellectual Property Office, the disclosures of which are incorporated by reference herein in their entireties.

### BACKGROUND

The present application relates to the electronic design of image sensors, and more specifically, to a device and method for automating the design of image sensors.

The development of semiconductor devices such as integrated circuits is becoming increasingly complex. As a result, the time and costs for designing the semiconductor devices are also increasing.

In some cases, image sensors include various types of elements. For example, the image sensors may include photoelectric elements, analog elements, and digital elements. An analog signal generated by the photoelectric element may be output through an analog element and a digital element. For example, when the development of the image sensor is performed based on a signal transmission process, substantial time for designing the image sensor may be needed. For example, when a design related to the digital element is performed after a design related to the analog element is completed, a design of each stage might not be carried out simultaneously.

### SUMMARY

A computing system including at least one processor, and a non-transitory computer-readable storage medium electrically connected to the at least one processor and storing a command executed by the at least one processor, where when the command is executed through the at least one processor, the command causes the at least one processor to: obtain a target product specification information describing a target image sensor, generate a design element based on the target product specification information, and generate, using a model generation module, a design model of the target image sensor based on the target product specification information and the design element, wherein the design model includes at least one of a layout model, a circuit model, a test model, or a process model of the target image sensor.

A computing system including at least one processor and a non-transitory computer-readable storage medium electrically connected to the at least one processor and storing a command executed by the at least one processor, wherein when the command is executed through the at least one processor, the command causes the at least one processor to: obtain a target product specification information including a specification of a target image sensor, and generate, using a model generation module, a design model of the target image sensor based on the target product specification information, wherein the design model includes at least one of a layout model, a circuit model, a test model, or a process model of the target image sensor.

A computing system including at least one processor and a non-transitory computer-readable storage medium electrically connected to the at least one processor and storing a command executed by the at least one processor, wherein when the command is executed through the at least one processor, the command causes the at least one processor to: obtain a target product specification information describing a target image sensor, and generate, using a model generation module, a design model of the target image sensor based on the target product specification information and the design element. In one aspect, the design model includes at least one of a layout model, a circuit model, a test model, or a process model of the target image sensor, and each of the layout model, the circuit model, the test model, and the process model is configured to be independently modified using a plurality of interface components, respectively.

### BRIEF DESCRIPTION OF DRAWINGS

FIG. 1 is an example of a diagram of a computing system for designing an image sensor according to an embodiment of the present inventive concept.

FIG. 2 is an example of a diagram of a user interface provided to a user system by the computing system according to the embodiment of FIG. 1.

FIG. 3 is an example of a diagram of a structure of analysis data for designing an image sensor.

FIG. 4 is an example of a diagram of a machine learning model configured to generate an image sensor design model.

FIG. 5 is an example of a diagram of a statistical method for generating an image sensor design model.

FIG. 6 is an example of a diagram of a by-stage design module of an image sensor.

FIG. 7 is an example of a diagram of a layout model of an image sensor.

FIG. 8 is an example of a diagram of a simulation of a layout model of an image sensor.

FIG. 9A is an example of a diagram of a circuit model of an image sensor.

FIG. 9B is an example of a diagram of a pixel of a circuit model of an image sensor depicted in FIG. 9A.

FIG. 9C is an example of a diagram of control signal transmission of a circuit model of an image sensor.

FIGS. 10A and 10B are examples of diagrams of a simulation of a circuit model of an image sensor.

FIG. 11 is an example of a diagram of a test design module of an image sensor.

FIG. 12 is an example of a diagram of a process design module of an image sensor.

FIG. 13 is an example of a diagram of a computing system for a designing an image sensor according to an embodiment of the present inventive concept.

### DETAILED DESCRIPTION

The present disclosure relates to providing a computing system and method for designing an image sensor that can automate the design of the image sensor and perform design stages of the image sensor independently. In one aspect, the computing system includes a model generation module configured to generate a design model based on a product specification information. In one aspect, the design model includes a layout model, a circuit model, a test model, and a process model. In some aspect, a layout design module is configured to receive the layout model and provide the layout model to a first interface component. In some aspect, a circuit design module is configured to receive the circuit model and provide the circuit model to a second interface component. In some aspect, a test design module is configured to receive the test model and provide the test model to a third interface component. In some aspect, a process design module is configured to receive the process model and provide the process model to a fourth interface component. By providing each of the layout model, the circuit model, the test model, and the process model to a plurality of interface components via a plurality of processors, respectively, the time and cost for designing the image sensor can be reduced. In addition, by using multiple processors in parallel to modify each of the layout model, the circuit model, the test model, and the process model, the efficiency of a computing device can be increased.

Hereinafter, embodiments of the present inventive concept is described in detail with reference to the accompanying drawings. In some cases, the same or similar reference numerals are used for the same element or similar elements. In some cases, redundant descriptions thereof may be omitted.

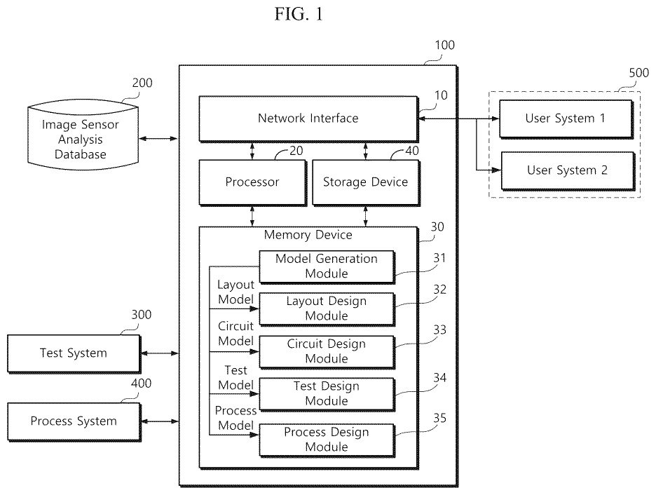

FIG. 1 is an example of a diagram of a computing system for designing an image sensor according to an embodiment of the present inventive concept. For example, the example shown includes computing system 100, image sensor analysis database 200, a test system 300, a process system 400, and user systems 500.

Referring to FIG. 1, the computing system 100 may communicate with an image sensor analysis database 200, a test system 300, a process system 400, and one or more user systems 500. The computing system 100 may perform electronic design automation (EDA) of the image sensor in an electronic circuit design process. In some cases, the computing system 100 may verify a layout, circuit design, test design, and process design of the image sensor.

In some aspects, the computing system 100 may include a network interface 10, a processor 20, a memory device 30, and a storage device 40. In one aspect, the memory device 30 includes a model generation module 31, a layout design module 32, a circuit design module 33, a test design module 34, and a process design module 35.

The network interface 10 may communicate with the image sensor analysis database 200, the test system 300, the process system 400, and the user systems 500. In some cases, the network interface 10 may transmit and receive data. In some cases, a bus is used in the network interface 10 to transmit and receive data.

The processor 20 may execute commands. The commands may be stored in the storage device 40 and temporarily stored in the memory device 30 for execution by the processor 20. In some cases, the processor 20 may include one or more processors. In some cases, processor 20 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some aspects, the network interface 10 may include a wireless transceiver or a wired transceiver. For example, the wireless transceiver may include at least one of a mobile communication module, a wireless Internet module, a short-range communication module, or a location information module.

In some aspects, the mobile communication module transmits and receives wireless signals with at least one of a base station, an external terminal, or a server in a mobile communication network established based on a long term evolution (LTE). For example, LTE is a communication method for mobile communication.

In some aspects, the wireless Internet module is a module for wireless Internet access. In some cases, the wireless Internet module may be embedded in or externally located on the computing system 100. In some cases, wireless LAN (WLAN), wireless fidelity (Wi-Fi), wireless fidelity (Wi-Fi) direct, digital living network alliance (DLNA), or the like may be used.

In some aspects, the short-range communication module is a module for transmitting and receiving data through short-range communication and Bluetooth™. In some cases, radio frequency identification (RFID), infrared data communication (IrDA), ultra wideband (UWB), Zigbee, near field communication (NFC), or the like may be used in the short-range communication module.

The processor 20 may be singular or plural. The processor 20 may include a computation core, an artificial intelligence (AI) core, a digital signal processing core, and a neural network accelerator core.

In some aspects, the memory device 30 may temporarily store a command instructing an operation of the processor 20. The command may be part of a program. The program may be designed and configured for the present disclosure or may be known and available for use by those skilled in the art of computer software. Examples of programs may include not only machine language code For example created by a compiler, but also high-level language code that can be executed by a computer using an interpreter or the like.

The storage device 40 may be a medium in which pieces of data are non-temporarily stored and which is readable by the processor 20. In some cases, the data includes the command. The storage device 40 may include all types of recording devices in which pieces of data readable by a computer system are non-temporarily stored. Examples of media readable by the computer system may include a hard disk drive (HDD), a solid state disk (SSD), a silicon disk drive (SDD), a ROM, a RAM, a CD-ROM, a magnetic tape, a floppy disk, an optical data storage device, etc.

The processor 20 according to an embodiment of the present inventive concept may execute the command stored in the memory device 30 and generate at least one design model of a target image sensor based on requested product specification information of the target image sensor. For example, the target image sensor is an image sensor to be designed. The computing system 100 may perform a development such as a modification by an engineer or a design modification on a design module generated based on the requested product specification information. For example, some of the design models may include pieces of circuit design information such as an electrical circuit diagram, a high-level electrical format of a circuit design, and a synthesized circuit netlist.

The requested product specification information may include information about a specification for the target image sensor. For example, the requested product specification information may include specification information based on a demand of a user. In some cases, the requested product specification information may include pixel information and/or circuit information for the design. In one embodiment, the pixel information and circuit information for the design may be automatically generated by the computing system 100 based on the specification information provided by the user. In some embodiments, the pixel information and circuit information for the design may be provided by a designer (e.g., an image sensor designer), a design project planner, etc. based on the specification information provided by the user. In some embodiments, the pixel information and circuit information for the design might not be included in the requested product specification information. For example, the pixel information and circuit information for the design may be determined at each design stage.

For example, the specification information may include information such as a type of the target image sensor, a shooting resolution of the target image sensor, and a size of an active pixel array. The type of the target image sensor may refer to a spectral band that the image sensor may capture an image, such as a color image sensor or an infrared image sensor. In some cases, the specification information may include information about a function of the target image sensor. For example, the information about the function of the target image sensor may include an autofocusing function and/or a high dynamic range (HDR) image function for the target image sensor. In some embodiments, the specification information may include information about the image sensor performance. For example, the information about the image sensor performance may include a still image shooting rate (normal frame rate), a video shooting rate (video frame rate), or the like of the target image sensor.

For example, the pixel information for the design may include a pixel size, a resolution, a pixel pitch, a pixel type, and/or a color filter pattern. The pixel pitch is a distance between centers of pixels. The pixel size is a dimension of the pixel measured in horizontal and vertical directions. The resolution may refer to the number of pixels in row and column directions of a pixel array. The pixel type may be an operation type of the pixel based on pixel binning, such as a tetra pixel, a nona pixel, or a tetra squared pixel. In some embodiments, the pixel type may refer to the number of photodiodes included in each pixel. The color filter pattern may be an arrangement pattern of a color filter, such as a Bayer pattern.

For example, the circuit information for the design may include a size of a floating diffusion region and/or a size of a shared pixel. For example, the floating diffusion region is where charge from photodiodes is collected and converted to a voltage signal in an image sensor. In some aspects, the size of the floating diffusion region affects charge capacity, impacting dynamic range and noise performance. In some cases, the size of a shared pixel refers to how multiple photodiodes share readout structures, optimizing space and improving the sensor's light-sensitive area. In some cases, the size of the shared pixel affects resolution and readout efficiency.

The commands that enable the processor 20 to perform the design of the target image sensor may include a model generation module 31, a layout design module 32, a circuit design module 33, a test design module 34, and a process design module 35. In some cases, each of the model generation module 31, the layout design module 32, the circuit design module 33, the test design module 34, and the process design module 35 may be implemented as software stored in memory device 30 and executable by processor 20, as firmware, as one or more hardware circuits, or as a combination thereof.

The model generation module 31 may generate a by-stage design model of the target image sensor based on the requested product specification information of the target image sensor. The by-stage design model may be provided to the layout design module 32, the circuit design module 33, the test design module 34, and the process design module 35. In some cases, the by-stage design model includes a layout model, circuit model, test model, and process model. For example, a layout model may be provided to the layout design module 32, a circuit model may be provided to the circuit design module 33, a test model may be provided to the test design module 34, and a process model may be provided to the process design module 35.

The model generation module 31 may generate at least one design element based on the requested product specification information of the target image sensor and generate the design model that includes the design element. For example, a design element of the layout model may include various circuit elements associated with the pixels of the image sensor. The model generation module 31 may determine geometric characteristics of various circuit elements associated with the pixels of the image sensor based on the requested product specification information and generate the layout model including the circuit element based on the determined geometric characteristics. A design element of the test model may include a test item, a test input value for each test item, and a test result value. The model generation module 31 may determine the test item based on the requested product specification information and generate the test model including the test item. For example, the model generation module 31 may automatically generate at least some of the design elements included in each design model based on the product specification information and generate the design model based on the automatically generated design elements.

The design model may include at least one of the layout model, the circuit model, the test model, or the process model of the target image sensor. For example, the processor 20 may respectively generate all of the layout model, circuit model, test model, and process model of the target image sensor or may respectively generate one or more of the layout model, circuit model, test model, and process model of the target image sensor.

In an embodiment, the layout model may include information about the geometric characteristics of various circuit elements associated with the pixels of the image sensor. For example, the layout model may include information about an arrangement of at least one of the circuit elements such as a microlens, pixel, dummy pixel, dummy circuit, or connecting circuit of the target image sensor. The information about the arrangement may include information about a physical location, a physical size, or the like of the circuit element. The information about the arrangement of the microlens may refer to the number of pixels covered by one microlens or include information about whether the microlens is included. When the image sensor includes a stacked structure with a plurality of dies, the information about the arrangement of the connect circuit may include information about a type, a size, or the like of the connect circuit. For example, the type of the connect circuit may include through silicon via (TSV) and Cu-to-Cu bonding.

In an embodiment, the circuit model may include information about at least one of an arrangement of a circuit in the target image sensor, a connection relationship of an analog circuit, or a timing of a control signal of a digital circuit. The information about the arrangement of the circuit may include physical locations and sizes of regions in which various analog and digital circuit elements of the image sensor are disposed, and information about physical locations of the analog circuit elements. For example, the information about the arrangement of the circuit may include information about physical locations of pixel transistors. The circuit element may include wiring. In an embodiment, the circuit model may include information about a connection relationship between at least one of an output line, a power line, or a ground line and the pixel.

In an embodiment, the test model may include one or more test items to be performed in a wafer test and package test of the target image sensor, and/or information about test equipment corresponding to the test items. For example, the test items may include test items to be performed in the wafer test and/or test items to be performed in the package test. The test item may include a test item at a target location. For example, the test item may include an electrical test item at a target location of the analog circuit. For example, the electrical test item at the target location may correspond to the layout model and the circuit model.

In an embodiment, the process model may include at least one of a process parameter for manufacturing the target image sensor or a split test item. For example, a process parameter of an etching process may include an etch rate, an etch profile, an etch bias, selectivity, uniformity, residues and particle contamination, etc. In some cases, the process parameter may include a parameter of a process other than the etching process. The split test item may include whether at least one of lot split, shot split, wafer split, or in-chip split is performed. For example, the lot split refers to dividing a production batch to test different process conditions. For example, shot split tests variations withing exposure field on a wafer. For example, wafer split refers to the separation of wafers to test different treatments or process variations. For example, in-chip split refers to the application of different process conditions within different regions of the same chip.

In some embodiments, the processor 20 may generate at least one design model of the target image sensor using a statistical method based on the requested product specification information of the target image sensor. For example, a statistical method is used to predict performance outcomes, identify optimal design parameters, and assess the impact of variability on processes. In some cases, a similarity between the requested product specification information and the analysis data stored in the image sensor analysis database 200 is computed using Euclidean distance, cosine similarity, correlation coefficient, or statistical metrics.

In one embodiment, the processor 20 may compare the analysis data stored in the image sensor analysis database 200 with the requested product specification information. When the result of the comparison satisfies a predetermined condition, the processor 20 may generate at least one of the layout model, the circuit model, the test model, or the process model based on the analysis data.

For example, the processor 20 may generate the design model based on the analysis data when similarity between the requested product specification information of the target image sensor and the product specification information of the analysis data stored in the image sensor analysis database 200 satisfies a predetermined condition. For example, the product specification information and design results of previously developed image sensors may be stored in the image sensor analysis database 200. The processor 20 may generate the design model based on a result of designing the image sensor having the product specification information with the highest similarity to the requested product specification information.

In some embodiments, for example, the processor 20 may determine the image sensors having product specification information matching specification information provided by a user, and generate the design model based on a result of designing the image sensors with high similarity for each pixel information and circuit information for the design among the determined image sensors. For example, the processor 20 may generate the layout model based on a result of designing the image sensor with high pixel information similarity and generate the circuit model based on the design results of the image sensor with high circuit information similarity.

The processor 20 may generate at least one design model of the target image sensor using a deep learning-based method based on the requested product specification information of the target image sensor. For example, deep learning-based method is a type of machine learning that uses neural networks with multiple layers to learn complex patterns from a dataset. Similar to the human brain, these neural networks automatically extract features from an input dataset (e.g., unstructured dataset) and generate a prediction based on the input dataset. In some cases, a machine learning model (or a generative machine learning model) is used to generate the at least one design model of the targe image sensor based on the requested product specification information of the target image sensor.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory device 30 and executable by processor 20, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word.

In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In one embodiment, the processor 20 may input the requested product specification information of the target image sensor into a generative machine learning model and generate the design model using the generative machine learning model. The requested product specification information may be embedded into a feature space and then input into the generative machine learning model. In some cases, the requested product specification information may be encoded, using an encoder, to generate a feature embedding. In some cases, the feature embedding may be a vector representing circuit components and design parameters described by the requested product specification information. By using the feature embedding, the processor 20 is able to efficiently compare, cluster, or recognize pattern in design analysis to generate the design model, thereby improving the computing system.

In an embodiment, the generative machine learning model may include a generative adversarial network (GAN) or a generative pre-trained transformer (GPT). For example, the generative machine learning model may be a GPT model trained with pieces of analysis data of the image sensor analysis database 200.

In an embodiment, the processor 20 may generate a plurality of models based on the requested product specification information of the target image sensor. The processor 20 may rank the plurality of models based on a predetermined condition. The processor 20 may display the ranked models on a display device for the user.

For example, the processor 20 may generate a plurality of layout models and select one of the plurality of layout models or rank the plurality of layout models. In some cases, the ranking of the plurality of the layout models may be based on a score corresponding to a predetermined condition.

For example, when the similarity between the requested product specification information of the target image sensor and the product specification information of the analysis data stored in the image sensor analysis database 200 satisfies the predetermined condition, the processor 20 may generate the plurality of design models based on the analysis data associated with the corresponding product specification information. The processor 20 may rank the plurality of design models based on the similarity. In some cases, the processor 20 computes a similarity score between the requested product specification information of the target image sensor and the product specification information of the analysis data stored in the image sensor analysis database 200. In some cases, the processor 20 may rank the plurality of design models based on the similarity score.

In an embodiment, the computing system 100 may transmit the design model of the image sensor generated by the computing system 100 to at least one of the user systems 500 through the network interface 10. The design model may be a model of by-stage design models of the image sensor, where the by-stage design models include the layout model, the circuit model, the test model, and the process model.

In an embodiment, the computing system 100 may selectively transmit, to the test system 300 and/or the process system 400, one or more pieces of data included in the design results in which the user systems 500 have modified and confirmed the design model. For example, one or more pieces of data associated with the test system 300 and/or the process system 400 in the layout design, the circuit design, the test design, and the process design may be transmitted to the test system 300 and/or the process system 400. For example, the test item and/or type of test equipment of the test design may be transmitted to the test system 300, and the process parameter and/or split test item of the process design may be transmitted to the process system 400.

The computing system 100 may provide a different design model to each of the plurality of user systems 500 through the network interface 10. For example, the computing system 100 may provide the layout model of the target image sensor to a first user system (e.g., the user system 1) and provide the circuit model of the target image sensor to a second user system (e.g., the user system 2). For example, the computing system 100 may provide the by-stage design models generated for developing the same target image sensor to different user systems, and the different user systems may develop the provided design models through independent and/or parallel modifications. By providing the circuit model, the design models may be transmitted to the user systems 500, and design results in which designs have been completed may be received, or modifications of the design models of the user systems 500 may be reflected in real-time in a state in which online connection with the user systems 500 is maintained.

The computing system 100 may respectively generate the design model for various stages for designing the target image sensor based on the requested product specifications. In some cases, the computing system 100 may enable each of the plurality of user systems 500 to develop the generated design models in parallel, thereby shortening the time for designing the image sensor and reducing the costs. In some cases, the computing system 100 may automatically generate circuit elements to be designed at each stage for designing the image sensor and include the generated circuit elements in the design model, thereby shortening the time for designing the image sensor and reducing the costs.

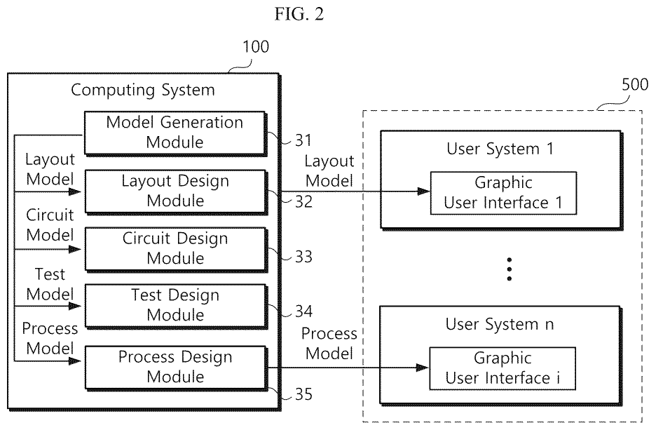

FIG. 2 is an example of a diagram of a user interface provided to a user system by the computing system according to the embodiment of FIG. 1. The computing system 100 and user system 500 of FIG. 2 may be an example of, or includes aspects of, the computing system 100 and the user system 500 of FIG. 1, respectively. A user interface provided to the computing system 100 and the user system 500 is described with reference to FIGS. 1 and 2.

The design models of the embodiment of the present inventive concept may each be provided to different design modules (e.g., the layout design module 32, the circuit design module 33, the test design module 34, and the process design module 35), and each of the design modules may provide the result to a different user interface to the user system 500 to modify the design model. The user interface may modify the design models independently in response to a user input of the user system 500. In some cases, the user interface may modify the design models jointly in response to a user input of the user system 500. In some cases, the user input may be referred to as an input command.

For example, referring to FIG. 2, the model generation module 31 may generate the by-stage design model of the target image sensor. For example, the layout model may be provided to the layout design module 32, the circuit model may be provided to the circuit design module 33, the test model may be provided to the test design module 34, and the process model may be provided to the process design module 35.

Referring to FIG. 2, the layout design module 32 may provide a user system 1 with the layout model and a user interface 1 for modifying the layout model, and the process design module 35 may provide the process model and a user interface i for modifying the process model to a user system n. The user interface 1 and the user interface i may be user interfaces with different structures and may be graphic-based user interfaces. The design modules may be performed as independent processes in the processor 20 of FIG. 1. For example, the user interface 1 for modifying the layout model may include a user interface configured to modify a location and/or size of a layout object. The user interface i for modifying the process model may include a user interface for modifying the process parameter value or changing the process parameter. In some embodiments, a first intermediate user interface may receive the circuit model from the circuit design module 33. In some embodiments, a second intermediate user interface may receive the test model from the test design module 34.

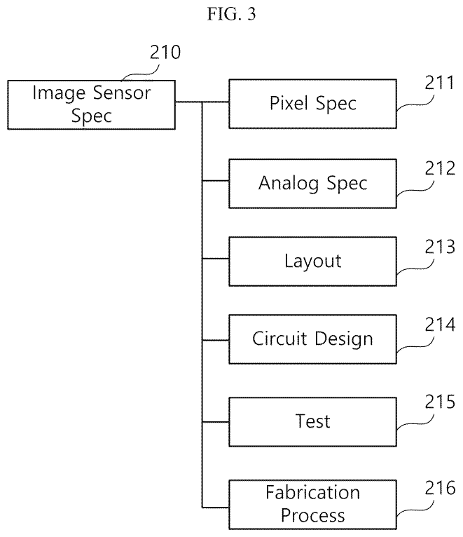

FIG. 3 is an example of a diagram of a structure of analysis data for designing an image sensor. The analysis data may be stored in the image sensor analysis database 200 of FIG. 1. The analysis data stored in the image sensor analysis database 200 is described with reference to FIGS. 1 and 3.

The image sensor analysis database 200 may be implemented as an internal device of the computing system 100 or as a separate database server. For example, when the image sensor analysis database 200 is implemented as the internal device of the computing system 100, the image sensor analysis database 200 may include data stored in the memory device 30 and/or the storage device 40 of FIG. 1.

The analysis data of the image sensor analysis database 200 of the embodiment of the present inventive concept may include product specification information of the image sensors and pieces of information related thereto. In some cases, the product specification information includes image sensor specification 210. For example, in the analysis data, the image sensor specification 210 of the developed image sensors and the design results associated with the product specification information may be stored. The design results may include the results of the by-stage design of the image sensor. For example, the results of the by-stage design of the image sensor may include the pixel specification 211, the analog specification 212, the layout 213 of the image sensor, the circuit design 214, information about a performed test process 215, and information used in a manufacturing process of the image sensor (e.g., the fabrication process 216).

In an embodiment, the image sensor specification 210 may include a type of the image sensor, a shooting resolution of the image sensor, and a size of an active pixel array. The type of the image sensor may refer to a spectral band that the image sensor may capture an image, such as a color image sensor or an infrared image sensor. The image sensor specification 210 of the image sensors may include information about a function of the image sensor. For example, the information about the function of the image sensor may include an autofocusing function and/or a high dynamic range (HDR) image function. In some embodiments, the image sensor specification 210 of the image sensors is not necessarily limited to the information described above.

In an embodiment, the pixel specification 211 may include a pixel pitch, a pixel type, and/or a color filter pattern. The pixel specification 211 is not necessarily limited to the information described above. For example, the pixel pitch refers to the distance between the centers of adjacent pixels in an image sensor, affecting resolution and image sharpness. For example, the pixel type refers to the structure or function of a pixel. For example, the color filter pattern refers to an arrangement of color filters over the pixels in an image sensor.

In an embodiment, the analog specification 212 may include the size of the floating diffusion region, the number of pixel output lines per column of the pixel array, the number of power voltage lines per the pixel, the number of ground lines per the pixel, and/or the size of the shared pixel. According to an embodiment, some items described above as the analog specification 212 may be included in the circuit design 214. For example, the number of pixel output lines per column of the pixel array, the number of power voltage lines per the pixel, and/or the number of ground lines per the pixel may be included in the circuit design 214. The analog specification 212 is not necessarily limited to the information described above.

In an embodiment, the layout 213 may include information about the geometric characteristics of various circuit elements associated with the pixel of the image sensor. For example, the layout 213 may include information about the arrangement of at least one of the circuit elements such as the microlens, pixel, dummy pixel, dummy circuit, or connect circuit of the target image sensor. The information about the arrangement may include information about the location and/or the size of the pixel. The information about the arrangement of the microlens may refer to the number of pixels covered by one microlens or include information about whether the microlens is included. When the image sensor includes a stacked structure having a plurality of dies, the information about the arrangement of the connect circuit may include information about the type, the size, or the like of the connecting circuit. The layout 213 is not necessarily limited to the information described above.

In an embodiment, the circuit design 214 may include analog circuit design and digital circuit design. For example, the analog circuit design may include an arrangement of an analog circuit region of the image sensor and/or a connection relationship of the analog circuit elements. The digital circuit design may include an arrangement of a digital circuit region, timing information of the control signal of the digital circuit, and/or information about a digital circuit mode.

In an embodiment, the information about the arrangement of the circuit may include information about a location and size of a region in which various analog and digital circuit elements are disposed and locations of the analog circuit elements of the image sensor. The circuit element may include wiring. The circuit design 214 may include a connection relationship between the analog circuit element and the digital circuit element. The information about the circuit design 214 is not necessarily limited to the information described above.

In an embodiment, the timing information of the control signal of the digital circuit may include information about transition between high levels and low levels of control signals provided to each element over time. For example, the timing information of the control signal of the digital circuit may include the information about the transition of the control signals provided to the pixel transistors over time.

In an embodiment, the information about the digital circuit mode may include information about a shooting mode in which the digital circuit operates. For example, the shooting mode may be information instructing a still image shooting mode or information instructing a video shooting mode. In some cases, the shooting mode may be information instructing a normal image shooting mode or information instructing an HDR image shooting mode in the still image shooting mode.

In an embodiment, the information about the test process 215 of the image sensor may include the test items to be performed in a wafer test and package test of the image sensor and/or information about test equipment corresponding to the test items. The information about the test process 215 is not necessarily limited to the information described above.

In an embodiment, the information used in the manufacturing process of the image sensor (e.g., the fabrication process 216) may include at least one of the process parameter for manufacturing the target image sensor or the split test item. The split test item may include whether at least one of lot split, shot split, wafer split, or in-chip split is performed. The information used in the fabrication process 216 (e.g., a manufacturing process) is not necessarily limited to the information described above.

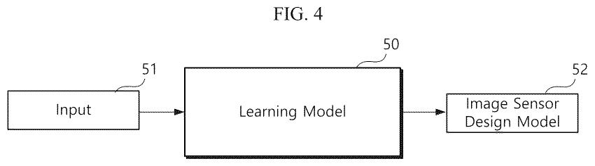

FIG. 4 is an example of a diagram of a machine learning model configured to generate an image sensor design model 52. The machine learning model 50 that generates the image sensor design model 52 may be used by the model generation module 31 of the computing system 100 of FIG. 1. For example, the model generation module 31 described with reference to FIG. 1 includes the machine learning model 50. The machine learning model 50 that generates the image sensor design model 52 is described with reference to FIGS. 1, 3, and 4.

The machine learning model 50 of the present inventive concept may include a plurality of learning models. The machine learning model 50 may include the plurality of learning models associated with the by-stage design model. For example, the machine learning model 50 may include a learning model trained to generate the layout model of the target image sensor based on the product specification information, a learning model trained to generate the circuit model of the target image sensor based on the product specification information, a learning model trained to generate the test model of the target image sensor based on the product specification information, and a learning model trained to generate the process model of the target image sensor based on the product specification information. In some embodiments, the machine learning model 50 includes a learning model trained to generate the layout model, the circuit model, the test model, and the process model of the target image sensor based on the product specification information.

In an embodiment, the machine learning model 50 may be a deep learning-based learning model. For example, the machine learning model 50 may be a deep model using multiple layers of models to generate at least one design model (output) for the requested product specification information (input 51) of the target image sensor. For example, the machine learning model 50 may include a deep neural network that includes an output layer and one or more hidden layers configured to apply nonlinear transformation to an input 51 to generate an output (e.g., the image sensor design model 52).

In an embodiment, the machine learning model 50 may include an embedding neural network. For example, the embedding neural network may be configured to process the requested product specification information of the target image sensor to generate embedding data that represents the design model. The embedding data may be input into the generative learning model. For example, an embedding is a learned representation of data in a continuous vector space where similar elements are mapped close to each other. The embedding transforms complex data, such as words, sentences, images, or nodes in a graph, into fixed-size vectors that capture semantic or structural relationships within the data. Embeddings enable machine learning models to process and analyze high-dimensional data more efficiently

In an embodiment, the machine learning model 50 may include a generative learning model based on deep learning. For example, the generative learning model may include a generative neural network architecture that enables the generation of the design model. The generative neural network may include a plurality of neural network layers connected in linear sequences. The neural network layer may include a convolutional layer, a fully-connected layer, a self-attention layer, etc. Some neural network layers may include a transformer. The generative neural network may be configured to process the embedding data using one or more neural network layers to generate data that represents a parameter of a probability distribution for a latent space. The latent space may be, for example, an N-dimensional Euclidean space, and the parameter defining the probability distribution may be a mean vector and covariance matrix of a normal probability distribution for the latent space. The generative neural network may sample a latent variable from the latent space based on the probability distribution for the latent space. The generative neural network may process the sampled latent variable using one or more neural network layers to generate an individual probability distribution for a set of individual elements of the design model. Subsequently, the generative neural network may sample each of the individual elements according to the corresponding probability distribution for the set of the individual elements of the design model and output the design model. In addition to the above, various types of generative neural network architectures may be used in the machine learning model 50.

According to an embodiment, the machine learning model 50 may be based on a transformer structure. In an embodiment, the plurality of learning models associated with the by-stage design model may be based on different network structures. For example, the learning model trained to generate the layout model may be based on a GAN model, and the learning models trained to generate different design models may be based on a GPT model. In some embodiments, the plurality of learning models associated with the by-stage design model may be based on the same network structure. For example, the plurality of learning models may be based on the GAN model or may be based on the GPT model.

In some aspects, the machine learning model 50 may be trained to generate the design model using the requested product specification information of the target image sensor as an input. The requested product specification information may include specification information provided by a user, and pixel information, and/or circuit information for the design. The machine learning model 50 may be trained using the analysis data from the image sensor analysis database 200 as training data.

For example, the machine learning model 50 trained to generate the layout model may be trained using training data including the pieces of analysis data related to the image sensor specification 210, the pixel specification 211, the analog specification 212, and the layout 213 of the image sensors described with reference to FIG. 3. The training data used to generate the layout model may include information about the geometric characteristics of various circuit elements associated with the pixel of the image sensor.

For example, the machine learning model 50 trained to generate the circuit model may be trained using training data including the pieces of analysis data related to the image sensor specification 210, the pixel specification 211, the analog specification 212, and the circuit design 214 of the image sensors described with reference to FIG. 3. The training data used to generate the circuit model may include circuit element information and wiring information. The circuit element information may include information about the arrangement of the circuit elements and the connection relationship of the circuit elements, and the wiring information may include information about at least one of the number of power lines, the number of ground lines, or the connection relationship between the output line and the pixel.

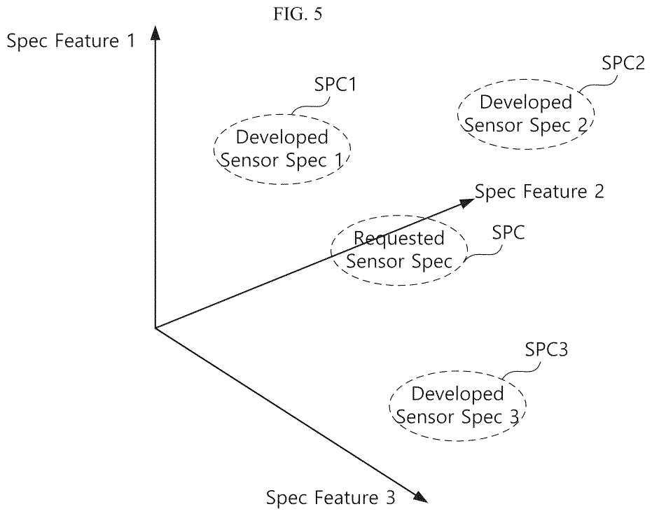

FIG. 5 is an example of a diagram of a statistical method for generating the image sensor design model. The statistical method for generating the image sensor design model may be used by the model generation module 31 of the computing system 100 described with reference to FIG. 1. The statistical method for generating the image sensor design model is described with reference to FIGS. 1, 3, and 4.

The computing system 100 may generate the design model based on a result of designing the image sensor having the product specification information with the highest similarity to the requested product specification information. The similarity may be calculated by various methods such as spatial distance and/or correlation.

In some embodiments, the computing system 100 may map the analysis data stored in the image sensor analysis database 200 described with reference to FIG. 3 to a space based on a specification feature of the image sensor specification 210, the pixel specification 211, and/or the analog specification 212 of the image sensors. For example, the computing system 100 may group the analysis data by developed image sensor and map the grouped analysis data to the space based on the specification feature. FIG. 5 is an example that shows three pieces of developed analysis data SPC1, SPC2, and SPC3 of the image sensors that are mapped to a space based on three exemplary specification feature vectors. For example, the specification feature vectors includes the first specification feature vector (e.g., Spec Feature 1), the second specification feature vector (e.g., Spec Feature 2), and the third specification feature vector (e.g., Spec Feature 3).

In some cases, the computing system 100 may map the requested product specification information SPC of the target image sensor to the space based on the specification feature of the analysis data.

In an embodiment, the computing system 100 may generate the design model based on the analysis data of the image sensor having a close spatial distance with the requested product specification information SPC of the target image sensor mapped to the space based on the specification feature of the analysis data. In some cases, for example, the spatial distance may be measured based on a Manhattan distance, an Euclidean distance, a standardized distance, a Mahalanobis distance, a Jaccard distance, or a cosine distance. In some embodiments, the computing system 100 may generate the design model based on the analysis data of the image sensor having a high correlation with the requested product specification information SPC of the target image sensor mapped to the space based on the specification feature of the analysis data. In some cases, for example, the correlation may be measured based on a correlation coefficient or mutual information.

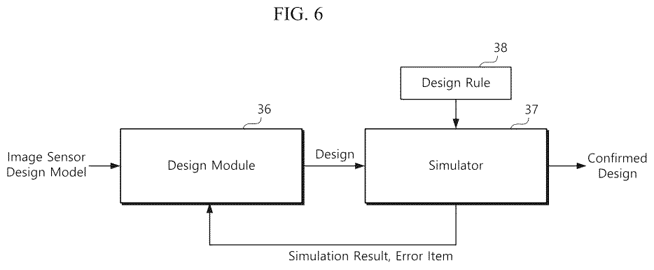

The computing system 100 may generate the design model based on a result of designing the image sensor having the product specification information with the highest similarity to the requested product specification information or generate each design model based on a result of designing image sensors in which the similarity to the requested product specification information is equal to or greater than a predetermined condition. When the plurality of design models related to the same design stage are generated, the simulation described with reference to FIG. 6 may be performed on the plurality of design models, and one of the design models may be determined based on a result of the simulation.

FIG. 6 is an example of a diagram of a by-stage design module of an image sensor. The by-stage design module in FIG. 6 may be an example of, or includes aspects of, the layout design module 32, the circuit design module 33, the test design module 34, or the process design module 35 of the computing system 100 in FIG. 1. The by-stage design module that generates the image sensor design model is described with reference to FIGS. 1 and 6.

In an embodiment, at least one of the design modules (e.g., the layout design module 32, the circuit design module 33, the test design module 34, or the process design module 35) of the present inventive concept may include a design module 36, a simulator 37, and a design rule 38. In one embodiment, one or more of the design modules might not include the simulator 37 and the design rule 38.

In some aspects, the design modules may receive the design model (e.g., the image sensor design model) generated by the model generation module 31 in FIG. 1. The design model may be one of the by-stage design models and may be, for example, one of the layout model, the circuit model, the test model, and the process model.

The design module 36 may enable an engineer to modify the design model through the user interface or modify the same by the design module 36. For example, the design module generates a modified design model based on the design model. In some aspects, the modified design model is provided to the simulator 37.

The simulator 37 may perform verification on the design by referring to the design rule 38. The verification may check whether the design provided by the design module 36 satisfies the design rule 38. The design rule 38 may include geometrical figures of the design elements and/or preset test inputs. For example, the simulator 37 may perform a design rule check (DRC) related to geometric characteristics such as sizes, distances, or the like of preset specific design elements (the circuit element, the layout object, etc.). In some embodiments, the simulator 37 may check whether an operation based on the provided design is properly performed on the preset test inputs. For example, the simulator 37 may check whether the pixels based on the circuit model generate an output signal according to a preset pixel driving pattern.

In an embodiment, when the design provided by the design module 36 does not satisfy the design rule 38, the simulator 37 may provide feedback of the simulation results and/or error items to the design module 36. The design module 36 may enable the engineer to re-modify the design model through the user interface or re-modify the same by the design module 36 based on the feedback.

In an embodiment, the modification of the design model by the design module 36 may refer to changing the geometrical characteristics of the preset specific design elements (the circuit element, the layout object, etc.). For example, the design module 36 may automatically modify the layout model by moving a location of the layout object or changing the size of the layout object within a predetermined range. The design module 36 may automatically modify the circuit model by changing a location of the circuit element or changing a connection relationship of the circuit element. When the verification of the design by the simulator 37 is successful, the simulator 37 may output a confirmed design. In some cases, when the verification fails, the design module 36 may proceed with re-modification of the design model until the verification of the design is successful.

In an embodiment, the simulator 37 may perform verification on the design based on the requested product specification information. For example, the simulator 37 may check whether the design provided by the design module 36 satisfies the specification information provided by the user, and the pixel information and/or circuit information for the design. For example, the simulator 37 may check whether the layout design obtained by modifying the layout model by the design module 36 satisfies the shooting resolution and/or the size of the pixel array of the specification information. When the analog circuit is operated based on the information of the control signal timing of the digital circuit, the simulator 37 may check whether the circuit design obtained by modifying the circuit model by the design module 36 satisfies the shooting rate of the specification information. In some cases, the simulator 37 may check whether the design satisfies values of items included in the specification information, and the pixel information and/or circuit information for the design.

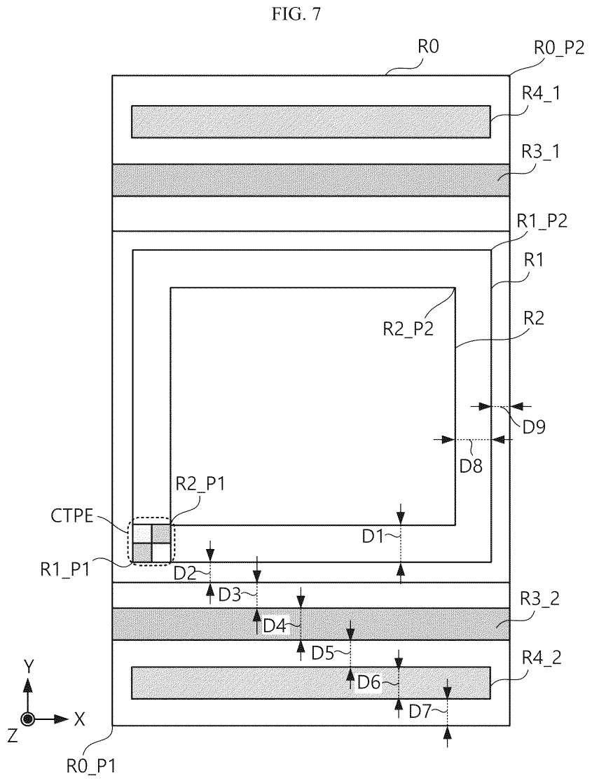

FIG. 7 is an example of a diagram of the layout model of the image sensor. The layout model in FIG. 7 may correspond to the layout model generated by the model generation module 31 of the computing system 100 in FIG. 1. An embodiment of the layout model of the image sensor is described with reference to FIGS. 1 and 7.

In an embodiment, the layout model may include information about the geometric characteristics of various layout objects of the pixel array. For example, referring to FIG. 7, the layout object may include an active pixel array, a microlens, an active pixel, a dummy pixel, a dummy circuit, a connect circuit, etc. The geometric characteristics may include characteristics related to various physical shapes and locations such as a location, length, distance, area, and spacing of the layout object. The geometric characteristics of the microlens may refer to a location, distance, area of the microlens and/or the number of pixels covered by one microlens, or include information about whether the microlens is included.

In an embodiment, the information about the geometric characteristics of the layout objects in the layout model may include coordinate information, spacings, etc. of points constituting the layout object.

For example, the layout model may include, in a plane (X-Y plane) parallel to a substrate of the image sensor, coordinates R0_P1 and R0_P2 of diagonal corner points of an image sensor R0, coordinates R1_P1 and R1_P2 of diagonal corner points of a pixel array R1, and coordinates R2_P1 and R2_P2 of diagonal corner points of an active pixel array R2. In some cases, for example, the layout model may include areas D1 and D8 of an active dummy, areas D2 and D9 of an open dummy, an area D3 of an optical black dummy, etc. In some cases, the diagonal corner points refers to the points located at the intersection of the diagonal lines extending to the corners of a shape, such as a rectangle or a square. For example, the coordinate R0_P1 may be located at the bottom left corner of the image sensor R0 and the coordinate R0_P2 may be located at the top right corner of the image sensor R0.

In some cases, the layout model may include areas and spacings D3, D4, D5, D6, and D7 of the pixels R3_1, R3_2, R4_1, and R4_2 (dummy pixels, optical black pixels, etc.) used for various inventive concepts. Based on the layout model, the active dummy may be disposed at four sides of the pixel array R1 or disposed at some sides. Based on the layout model, shapes and/or numbers of pixels R3_1, R3_2, R4_1, and R4_2 (dummy pixels, optical black pixels, etc.) used for various inventive concepts may vary.

In an embodiment, the layout model may include information (CTPE) about a color filter pattern of a pixel. In an embodiment, the layout model may include numerical data. For example, the user interface provided by the layout design module 32 of FIG. 2 to the user system 500 may show a shape of the layout object by decoding the layout model.

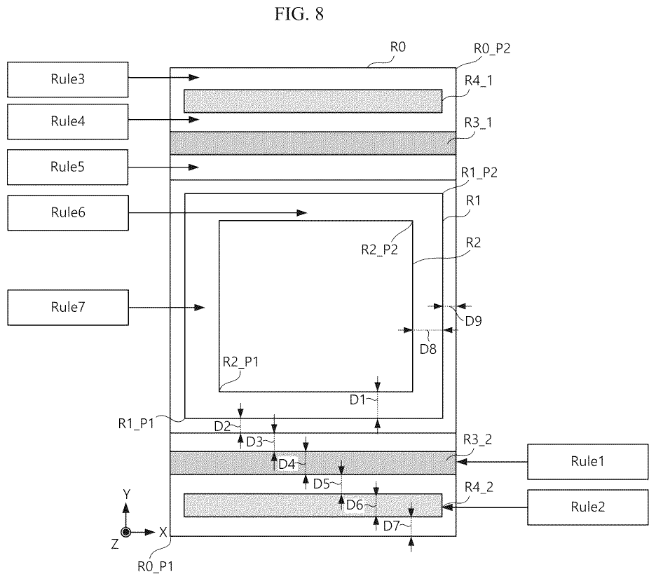

FIG. 8 is an example of a diagram of a simulation of the layout model of the image sensor. The layout model in FIG. 8 may be an example of, or includes aspects of, the layout model generated by the model generation module 31 of the computing system 100 in FIG. 1. The simulator 37 in FIG. 6 may perform the simulation of the layout model in FIG. 8. An embodiment of the simulation of the layout model of the image sensor is described with reference to FIGS. 1, 6, and 8.

In an embodiment, the simulator 37 in FIG. 6 verifies the design based on the design rule 38. The design rule 38 may include geometrical figures of the design elements and/or preset test inputs.

For example, the simulator 37 may perform verification on whether the area D4 of the layout object R3_2 satisfies a design rule 1. The simulator 37 may perform verification on whether the area D6 of the layout object R4_2 satisfies a design rule 2. The simulator 37 may perform verification on whether a spacing of the layout object R4_1 from the boundary of the image sensor R0 satisfies a design rule 3. The simulator 37 may perform verification on whether a spacing between the layout objects R4_1 and R3_1 satisfies a design rule 4. The simulator 37 may perform verification on whether the area D3 of the open dummy satisfies a design rule 5. The simulator 37 may perform verification on whether the areas D1 and D8 of the active dummy satisfy design rules 6 and 7, respectively. In some cases, the simulator 37 may perform various verifications on the geometric characteristic such as whether the layout objects overlap each other.

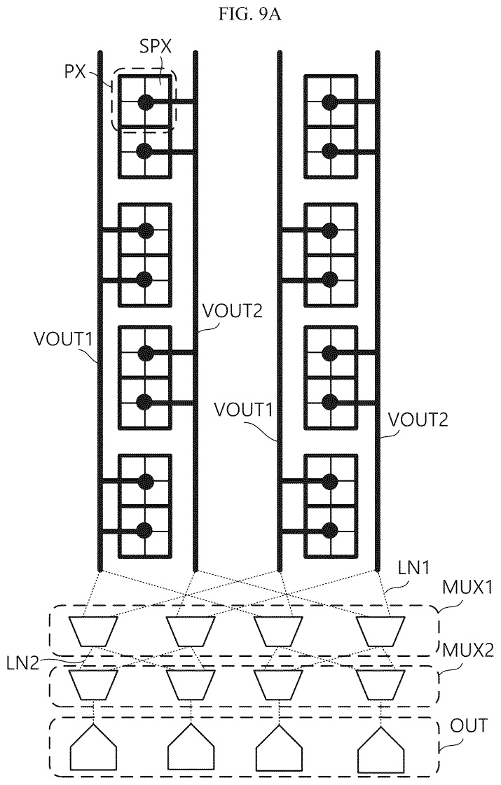

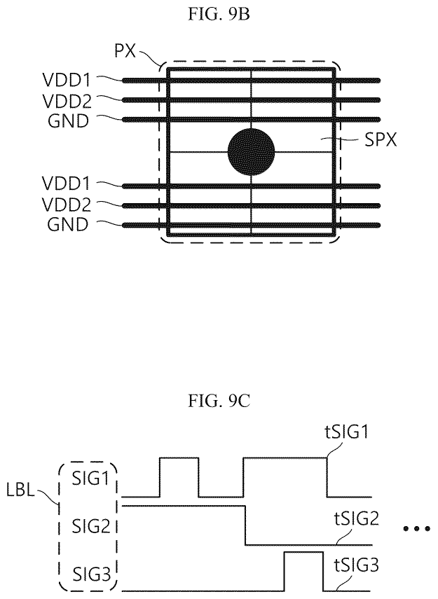

FIGS. 9A, 9B, and 9C are example diagrams of the circuit model of the image sensor. The circuit models in FIGS. 9A, 9B, and 9C may correspond to the circuit models generated by the model generation module 31 of the computing system 100 in FIG. 1. Embodiments of the circuit model of the image sensor are described with reference to FIGS. 1, 9A, 9B, and 9C.

FIG. 9A is an example of a diagram of the circuit model of the image sensor. Referring to FIG. 9A, pixels PX in FIG. 9A may be shown to show information about a connection relationship between the pixels PX and output lines VOUT1 and VOUT2 without showing an actual layout arrangement of the pixels PX. In some cases, the pixel PX has a pixel type in which four sub-pixels SPX are commonly connected to the output line.

In an embodiment, the circuit model may include information about the connection relationship between the plurality of pixels PX and the output lines VOUT1 and VOUT2. For example, referring to FIG. 9A, the circuit model may include information that a plurality of pixels PX disposed in the same column are alternately connected to different output lines VOUT1 and VOUT2 every two pixels. For example, the first two pixels are connected to output line VOUT1 and the subsequent two pixels are connected to the output line VOUT2. In some cases, the circuit model may include information that the plurality of pixels PX disposed in the same column provide output signals through two output lines VOUT1 and VOUT2.

In an embodiment, the circuit model may include information about a connection relationship between the output lines VOUT1 and VOUT2 and digital circuits (e.g., the first multiplexer circuit MUX1 and the second multiplexer circuit MUX2). For example, referring to FIG. 9A, the circuit model may include information that the output lines VOUT1 and VOUT2 are each connected to the first multiplexer circuit MUX1 through a first wiring LN1, and the first multiplexer circuits MUX1 are connected to the second multiplexer circuit MUX2 through the second wiring LN2.

According to an embodiment, the circuit model includes the connection relationships between the wirings LN1 and LN2 and/or the output lines VOUT1 and VOUT2. In some cases, the circuit model includes numerical data such as areas and/or lengths of the wirings LN1 and LN2 and/or the output lines VOUT1 and VOUT2.

FIG. 9B is an example of a diagram of a pixel of the circuit model of the image sensor. In an embodiment, the circuit model may include information about a connection relationship between one of the power line, the ground line, and the pixel. The information about the connection relationship between one of the power line, the ground line, and the pixel may include information about the number of power lines VDD1 and VDD2 provided to the pixel PX, the number of ground lines GND, areas of the power lines VDD1 and VDD2, and/or an area of the ground line GND.

FIG. 9C is an example of a diagram of control signal transmission of the circuit model of the image sensor. In an embodiment, the circuit model may include information about control signals SIG1, SIG2, and SIG3 provided to the pixel PX. For example, the circuit model may include a label LBL of the control signals SIG1, SIG2, and SIG3, and control signal changes tSIG1, tSIG2, and tSIG3 in high level and low level during a reference time of the control signals SIG1, SIG2, and SIG3.

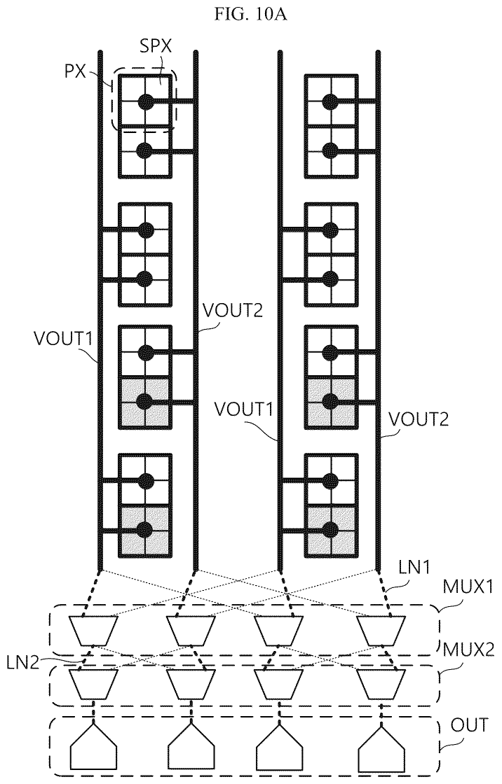

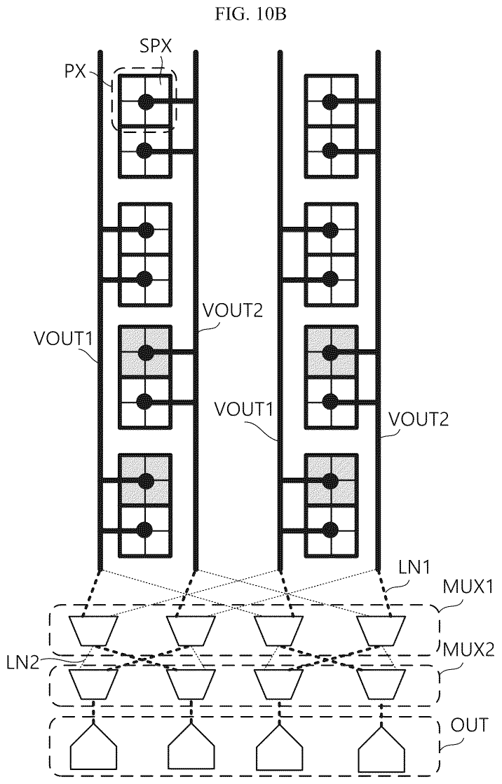

FIGS. 10A and 10B are examples of diagrams of a simulation of the circuit model of the image sensor. The circuit models in FIGS. 10A and 10B may correspond to the circuit models generated by the model generation module 31 of the computing system 100 in FIG. 1. The simulator 37 in FIG. 6 may perform the simulation of the circuit model in FIGS. 10A and 10B. An embodiment of the simulation of the circuit model of the image sensor is described with reference to FIGS. 1, 6, 10A, and 10B.

In an embodiment, the simulator 37 in FIG. 6 may check whether the pixels PX of the circuit model generate the output signal according to a predetermined pixel driving pattern. The pixel driving pattern may refer to the order of transmitting the output signals according to a readout operation of the pixels PX based on a pixel control signal. The pixel driving pattern may be included in the circuit model or determined by an engineer. The simulator 37 may check the transmission order of the output signals during the readout operation of the pixels PX based on the information about the connection relationship between the pixels PX and the output lines VOUT1 and VOUT2, the information about the connection relationship between the output lines VOUT1 and VOUT2 and the digital circuits MUX1 and MUX2 in FIG. 9A of the circuit model, and the pixel control signal provided to the pixels PX in FIG. 9C.

The simulator 37 in FIG. 6 may compare the transmission order of the output signals of the pixels PX with the pixel driving pattern. The simulator 37 in FIG. 6 may display the pixels PX differently on a display device based on the sequence in which the pixels PX transmit output signals during the readout operation of the pixels PX. In an embodiment, the pixels PX may be shown, on the display, differently in the order of transmitting the output signals during the readout operation of the pixels PX. For example, among pixels in column 1 and column 2, FIG. 10A shows that first and third pixels, on the display, from the bottom transmit output signals. In some aspects, FIG. 10B shows that second and fourth pixels in column 1 and column 2, on the display, from the bottom transmit output signals. In FIGS. 10A and 10B, the pixels, on the display, transmitting the output signals are marked by dot patterns. Among the wirings LN1 and LN2, wirings that transmit the output signals are represented by thick dotted lines.

In an embodiment, as a result of the verification of the simulator 37 in FIG. 6, when the transmission order of the output signals during the readout operation of the pixels PX does not match the pixel driving pattern, the design module 36 in FIG. 6 may modify information about the connection relationship between the pixels PX and the output lines VOUT1 and VOUT2. In some embodiments, the design module 36 may increase or decrease the number of output lines. The design module 36 may change the information about the connection relationship between the pixels PX and the output lines based on the modified number of output lines.

FIG. 11 is an example of a diagram of a test design module of the image sensor. The test design module in FIG. 11 may be an example of, or includes aspects of, the test design module 34 in FIG. 1. The test design module 34 is described with reference to FIGS. 1 and 11.

Referring to FIG. 11, the test design module 34 may receive the test model generated by the model generation module 31 in FIG. 1. In some aspects, the text model may include the test items and the test equipment. The test model may include at least one of test information related to a test to be performed corresponding to the layout model and the circuit model, or information about test equipment corresponding to a test item. In an embodiment, the information about the test equipment may include identification information and/or a type of equipment to perform the test. The test design module 34 may provide the user system with a user interface to modify the test information or change the test equipment. The test information may include at least one of test items to be performed corresponding to the layout model and the circuit model, a test input value for each test item, or a test result value.

In an embodiment, the test design module 34 may communicate with the test system 300 in FIG. 1 to receive a schedule of the test equipment. The test design module 34 may change the identification information and/or the type of the test equipment based on the schedule of the test equipment.

In an embodiment, the test design module 34 may modify or check the test information of the test model and/or the information about the test equipment based on the test items. In some cases, the test design module 34 may output test design including the schedule of the test equipment.

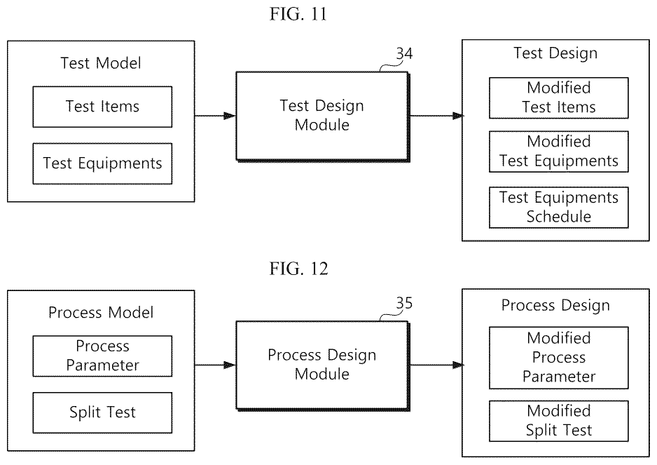

FIG. 12 is an example of a diagram of a process design module of the image sensor. The process design module in FIG. 12 is an example of, or includes aspects of, the process design module 35 in FIG. 1. The process design module 35 is described with reference to FIGS. 1 and 12.

Referring to FIG. 12, the process design module 35 may receive the process model generated by the model generation module 31 in FIG. 1. The process model may include at least one of the process parameter or split test item for manufacturing the target image sensor. In an embodiment, the process parameter may include a process parameter item and a process parameter value. The process design module 35 may provide the user system with a user interface to modify the process parameter item or modify the process parameter value.

In an embodiment, the process design module 35 may modify or check the process parameter item, the process parameter value, and/or the split test item of the process model and output the process design. In one aspect, the process design includes modified process parameter and/or the modified split test.

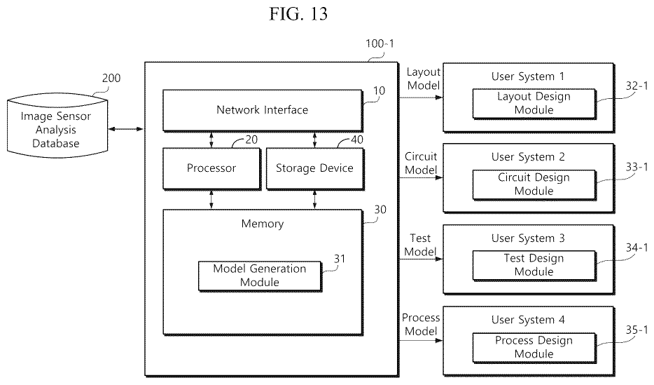

FIG. 13 is an example of a diagram of a computing system 100-1 for designing an image sensor according to an embodiment of the present inventive concept. Detailed descriptions of parts that overlap or are similar to the computing system 100 described with reference to FIG. 1 may be omitted.

Unlike the computing system 100 described with reference to FIG. 1, the commands that enable the processor 20 to perform the design of the target image sensor may include a model generation module 31 and might not include a layout design module 32-1, a circuit design module 33-1, a test design module 34-1, and a process design module 35-1.

Referring to FIG. 13, the layout design module 32-1, the circuit design module 33-1, the test design module 34-1, and the process design module 35-1 may each be performed in one of user systems. Therefore, design models (a layout model, a circuit model, a test model, and a process model) generated by the model generation module 31 may be provided to the layout design module 32-1, the circuit design module 33-1, the test design module 34-1, and the process design module 35-1 of the user system.

A device and method for designing an image sensor according embodiments of the present inventive concept can perform design stages of the image sensor independently. As a result, the time required for designing the image sensor can be shortened and costs can be reduced.

Meanwhile, the contents described above are embodiments for implementing the present invention. In addition to the embodiments described above, the present inventive concept includes embodiments that can be simply designed around or easily changed. In addition, the present invention includes technologies that can be easily modified and implemented using the embodiments. Therefore, the scope of the present invention should not be limited to the embodiments described above, but should be defined not only by the patent claims described below but also by the equivalents of the claims of this invention.

What is claimed is:

1. A computing system comprising:
at least one processor; and
a non-transitory computer-readable storage medium electrically connected to the at least one processor and storing a command executed by the at least one processor,
wherein when the command is executed through the at least one processor, the command causes the at least one processor to:
obtain a target product specification information describing a target specification of a target image sensor,
generate, using a feature encoder, a feature embedding based on the target product specification information, wherein the feature embedding represents the target specification in a feature space,
generate a design element based on the feature embedding, wherein the design element represent an electrical characteristic or a geometrical characteristic of the target image sensor, and
generate, using a model generation module, a design model of the target image sensor based on the target product specification information and the design element, wherein the design model includes at least one of a layout model, a circuit model, a test model, or a process model of the target image sensor.

2. The computing system of claim 1, wherein when the command is executed through the at least one processor, the command further causes the at least one processor to:
generate the layout model including information about an arrangement of at least one of a microlens, pixel, dummy pixel, or dummy circuit of the target image sensor as the design element,
generate the circuit model including information about at least one of an arrangement of an analog circuit, connection relationship of the analog circuit, or timing information of a control signal of a digital circuit of the target image sensor as the design element,
generate the test model including test information to be executed in a wafer test and package test of the target image sensor as the design element, and
generate the process model including at least one of a process parameter or a split test item for manufacturing the target image sensor as the design element.

3. The computing system of claim 1, wherein when the command is executed through the at least one processor, the command further causes the at least one processor to:
provide at least two or more of the layout model, the circuit model, the test model, and the process model of the target image sensor to two or more processors, respectively, and
independently modify the design model based on an input command.

4. The computing system of claim 3, wherein when the command is executed through the at least one processor, the command further causes the at least one processor to:
modify, using an interface component, the design model based on the input command, wherein the interface component includes a first interface and a second interface having a different structure than a structure of the first interface.

5. The computing system of claim 1, wherein when the command is executed through the at least one processor, the command further causes the at least one processor to:
execute a simulation based on the design model.

6. The computing system of claim 4, wherein when the command is executed through the at least one processor, the command further causes the at least one processor to:
compare the design model to a predetermined design rule and the target product specification information, and
update parameters of the design model based on the comparison.

7. The computing system of claim 1, wherein:
the model generation module includes a generative machine learning model trained to generate the design model based on the target product specification information.

8. The computing system of claim 7, wherein when the command is executed through the at least one processor, the command further causes the at least one processor to:
obtain training data including pixel information and layout information,
wherein the generative machine learning model is trained using the training data,
wherein the pixel information includes information about at least one of a color filter pattern, an autofocusing function, a size of a floating diffusion region, a pixel type, a pixel size, a resolution, or a pixel pitch, and
wherein the layout information includes information about geometric characteristics of at least one of a microlens, a pixel region, a dummy pixel region, a connect circuit region, or a dummy circuit region.

9. The computing system of claim 7, wherein when the command is executed through the at least one processor, the command further causes the at least one processor to:
obtain training data including circuit element information and wiring information,
wherein the generative machine learning model is trained using the training data,
wherein the circuit element information includes information about an arrangement of a circuit element and connection relationship of the circuit element, and
wherein the wiring information includes information about at least one of a number of power lines, a number of ground lines, or a connection relationship between an output line and a pixel.

10. The computing system of claim 1, further comprising:
a database storing analysis data of an image sensor,
wherein the analysis data includes at least one of product specification information of the image sensor and pixel information, analog information, layout, circuit design, test item, or process item associated with the product specification information.

11. The computing system of claim 10, wherein:
the design model is generated based on the analysis data.

12. The computing system of claim 11, wherein when the command is executed through the at least one processor, the command further causes the at least one processor to:
compute a similarity score based on the target product specification information of the target image sensor and the product specification information of the image sensor, wherein the design model is generated based on the similarity score.

13. The computing system of claim 1, wherein when the command is executed through the at least one processor, the command further causes the at least one processor to:
determine a geometric characteristic of a layout object based on the target product specification information of the target image sensor, wherein the layout model is generated based on the geometric characteristic.

14. The computing system of claim 13, wherein:
the layout object corresponds to at least one of a microlens, a pixel region, a dummy pixel region, or a dummy circuit region.

15. The computing system of claim 1, wherein when the command is executed through the at least one processor, the command further causes the at least one processor to:
determine a connection relationship between one of an output line, a power line, and a ground line and a pixel based on the target product specification information of the target image sensor, wherein the circuit model is generated based on the connection relationship.

16. The computing system of claim 15, wherein when the command is executed through the at least one processor, the command further causes the at least one processor to:
display a readout operation of the pixel of the circuit model based on timing information of a control signal of a digital circuit on a display device.

17. The computing system of claim 16, wherein when the command is executed through the at least one processor, the command further causes the at least one processor to:
update the connection relationship based on the readout operation.

18. The computing system of claim 1, wherein:
the test model includes at least one of a test item to be executed corresponding to the layout model and the circuit model, or information about test equipment corresponding to the test item.

19. A computing system comprising:
at least one processor; and
a non-transitory computer-readable storage medium electrically connected to the at least one processor and storing a command executed by the at least one processor,
wherein when the command is executed through the at least one processor, the command causes the at least one processor to:
obtain a target product specification information and a product specification information, wherein the target product specification information includes a target specification of a target image sensor and the product specification information includes specification of an image sensor,
generate, using a mapping encoder, a target feature embedding based on the target product specification information, wherein the target feature embedding represents the target specification in a feature space,
generate, using the mapping encoder, a feature embedding based on the product specification information, wherein the feature embedding represents the specification in the feature space,
compute a similarity score based on the target feature embedding and the feature embedding, and
generate, using a model generation module, a design model of the target image sensor based on the similarity score, wherein the design model includes at least one of a layout model, a circuit model, a test model, or a process model of the target image sensor.

20. A computing system comprising:
at least one processor; and
a non-transitory computer-readable storage medium electrically connected to the at least one processor and storing a command executed by the at least one processor,
wherein when the command is executed through the at least one processor, the command causes the at least one processor to:
obtain a target product specification information describing a target specification of a target image sensor, and
generate, using a feature encoder, a feature embedding based on the target product specification information, wherein the feature embedding represents the target specification in a feature space, and
generate, using a model generation module, a design model of the target image sensor based on the feature embedding,
wherein the design model includes at least one of a layout model, a circuit model, a test model, or a process model of the target image sensor, and
wherein each of the layout model, the circuit model, the test model, and the process model is configured to be independently modified using a plurality of interface components, respectively.
